(19) United States
(12) Patent Application Publication
(10) Pub. No.: US 2023/0336508 A1
(43) Pub. Date: Oct. 19, 2023

(54) MACHINE READABLE INDICIA-BASED MESSAGE DELIVERY

(71) Applicant: Simon Chamberlain, Winter Springs, FL (US)

(72) Inventor: Simon Chamberlain, Winter Springs, FL (US)

(21) Appl. No.: 18/102,077

(22) Filed: Jan. 26, 2023

Related U.S. Application Data
(60) Provisional application No. 63/303,273, filed on Jan. 26, 2022.

(51) Int. Cl. H04L 51/10

(52) U.S. Cl. CPC H04L 51/10; G06K 19/06037

(57) ABSTRACT

Computer-implemented methods, systems, and computer-readable media for recording, storing, and/or delivering machine-readable indicia-based messages are described herein.

### RELATED APPLICATION

This application claims the benefit of U.S. Application No. 63/303,273, entitled “MACHINE READABLE INDICIA-BASED MESSAGE DELIVERY”, filed on Jan. 26, 2022, which is incorporated herein by reference in its entirety.

### FIELD

Some implementations are generally related to systems and methods for recording messages, storing messages, and delivering messages (e.g., message delivery), and, in particular, those related to machine-readable indicia-based systems and methods for processing messages.

### BACKGROUND

Traditional methods of attaching audio and/or video messages to cards, gifts, or other objects can be cumbersome and expensive. Some implementations of the disclosed subject matter were conceived in light of the above-mentioned problems and/or limitations.

The background description provided herein is for the purpose of generally presenting the context of this disclosure. Work of the presently named inventor, to the extent it is described in this background section, as well as aspects of the description that may not otherwise qualify as prior art at the time of filing are neither expressly nor impliedly admitted as prior art against the present disclosure.

### SUMMARY

In some implementations, a machine-readable indicia-based system comprises a server system. In some implementations, the server system comprises a server device and a database. In some implementations, a value corresponding to a machine-readable indicium is received at the server system in response to the machine-readable indicium being scanned by a first client device. In some implementations, one or more media items associated with the value are received at the server system from the first client device. In some implementations, the value corresponding to the machine-readable indicium and the one or more media items are stored in the database and the value is associated with one or more media items in the database. In some implementations, in response to receiving the value and a request for the one or more media items from a second client device, the server system transmits the one or more media items from the server system through one or more networks to the second client device.

Some implementations include a method that comprises the receiving at a server system of a value corresponding to a scanned machine-readable indicium. In some implementations, the value is obtained by scanning the machine-readable indicium at a first client device. Some implementations include the receiving of one or more media items associated with the value from the first client device at the server system. Some implementations include the storing of the value corresponding to the machine-readable indicium and the one or more media items in a database. Some implementations include associating in the database the value corresponding to the machine-readable indicium with the one or more media items. Some implementations include the receiving of the value corresponding to the machine-readable indicium and a request for the one or more media items from a second client device. Some implementations include the transmitting of, from the server system, in response to the request for the one or more media items, the one or more media items to the second client device for presentation on the second client device.

Some implementations include a method that comprises the affixing of a machine-readable indicium to a product. Some implementations include the receiving at a server system of a value corresponding to a scanned machine-readable indicium. In some implementations, the value is obtained by scanning the machine-readable indicium at a first client device. Some implementations include the receiving of one or more media items associated with the value from the first client device at the server system. Some implementations include the storing of the value corresponding to the machine-readable indicium and the one or more media items in a database. Some implementations include associating in the database the value corresponding to the machine-readable indicium with the one or more media items. Some implementations include the receiving of the value corresponding to the machine-readable indicium and a request for the one or more media items from a second client device. Some implementations include the transmitting of, from the server system, in response to the request for the one or more media items, the one or more media items to the second client device for presentation on the second client device.

In some implementations, the machine-readable indicium may include one or more of a QR code, a 2-D barcode, a 3-D barcode, alphanumeric characters, or graphical symbols. In some implementations, the machine-readable indicium may be printed on one of a card, a gift, a product, a packaging, or a wrapping. In some implementations, the machine-readable indicium may be affixed as a sticker to one of a card, a gift, a product, a packaging, or a wrapping. In some implementations, the one or more media items may include one or more of a video recording, an audio recording, one or more images, one or more electronic documents, or one or more codes to access one or more electronic funds. In some implementations, the one or more of the one or more media items may be generated by a customer. In some implementations, one or more of the one or more media items may be generated by a service provider. In some implementations, one or more of the one or more media items may be generated by one or more of a customer or a service provider.

### BRIEF DESCRIPTION OF THE DRAWINGS

FIG. 1 is a block diagram of an example system and a network environment for retrieving an example message in accordance with some implementations.

FIGS. 2A and 2B are illustrative flowcharts showing example methods for recording or playing back one or more example messages in accordance with some implementations.

FIG. 3 is a block diagram of an example system and a network environment for retrieving an example message for a product in accordance with some implementations.

FIGS. 4A and 4B are illustrative flowcharts showing example methods for recording or retrieving example messages for a product in accordance with some implementations.

FIG. 5 is a block diagram of an example computing device that may be used for one or more implementations described herein.

### DETAILED DESCRIPTION

Some implementations include methods and systems for recording messages, storing messages, and playing back messages (message playback) based on machine readable indicia.

Particular implementations may realize one or more of the following advantages. An advantage of a media sharing system based on methods and system described herein is that a media item can be recorded by a first user and can be associated with a machine-readable indicium that is affixed to an object, such as a card, a gift, or other physical objects. The media item that is associated with the machine-readable indicium can then be stored. A second user, who is a recipient of the card, the gift, or the other physical object, can access the media item by using a device to read the machine-readable indicium and retrieve the stored media. Thus, a sender can record a message to a recipient, wherein the message is associated and stored with a machine-readable indicium, and wherein the recipient can access and play the stored message using the machine-readable indicium when the recipient chooses to retrieve such a message.

Yet another advantage is that the methods and systems described herein can provide a way for shoppers to receive an audio or a video message about a product (e.g., label information or additional information) by scanning a machine-readable indicium on the product to view and/or to listen to the label information or other information. For example, a shopper may have poor eyesight and may have difficulty reading a product label, such as a label on a medicine. An implementation of the disclosed subject matter can play the label information as an audio and/or video message when the shopper scans the machine-readable indicium on the product packaging.

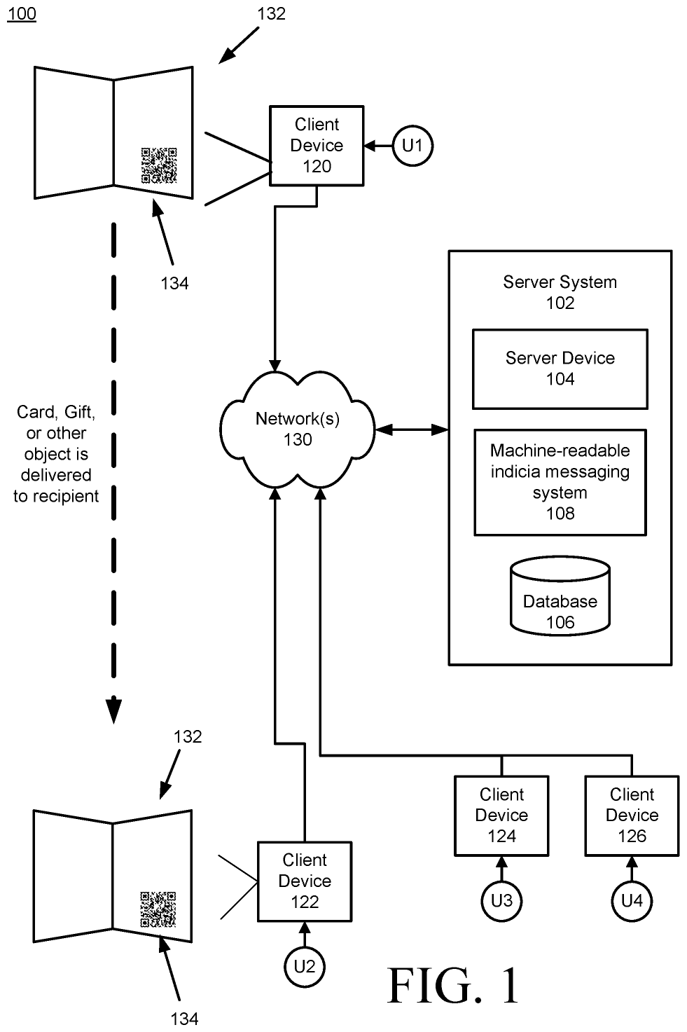

FIG. 1 is a block diagram of an example system and a network environment for retrieving an example message in accordance with some implementations. More specifically, FIG. 1 illustrates a block diagram of an example network environment 100, which may be used in some implementations described herein. In some implementations, the network environment 100 includes one or more server systems, e.g., a server system 102. Server system 102 can communicate with a network 130, for example. Server system 102 can include a server device 104 and a database 106 or other data store or data storage device. Network environment 100 also can include one or more client devices, e.g., client devices 120, 122, 124, and 126, which may communicate with each other and/or with the server system 102 via the network 130. Network 130 can be any type of communication network, including one or more of the Internet, local area networks (LAN), wireless networks, switch or hub connections, etc. In some implementations, the network 130 can include peer-to-peer communication between devices, e.g., using peer-to-peer wireless protocols.

For ease of illustration, FIG. 1 shows one block for each of the server system 102, the server device 104, and the database 106, and shows four blocks for client devices, i.e., one block each for 120, 122, 124, and 126. Some blocks (e.g., 102, 104, and 106) may represent multiple systems, several server devices, and multiple network databases. Also, the blocks can be provided in different configurations than shown in FIG. 1. For example, server system 102 can represent multiple server systems that may communicate with other server systems via the network 130. In some examples, database 106 and/or other storage devices can be provided in server system block(s) that are separate from the server device 104 and may communicate with the server device 104 and other server systems via the network 130. Also, there may be any number of client devices. Each client device can be any type of electronic device, e.g., desktop computer, laptop computer, portable or mobile device, camera, cellphone, smartphone, tablet computer, television, TV set-top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, the network environment 100 may not comprise all of the components shown in FIG. 1 and/or may have other elements, including other types of elements instead of, or in addition to, those described in FIG. 1.

In some implementations, end users U1, U2, U3, and U4 may communicate with the server system 102 and/or each other using respective client devices 120, 122, 124, and 126. In some examples, users U1, U2, U3, and U4 may interact with each other via applications running on the respective client devices 120, 122, 124, and 126, and/or through the server system 102, and/or via a network service, e.g., an image sharing service, a messaging service, a social network service, or other types of network service, implemented on the server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content that was previously uploaded to the server system 102 and/or a network service. In some implementations, the users can interact via audio or video conferencing, audio, video, or text chat, or other communication modes or applications. In some implementations, the network service can include any system that allows users to perform a variety of communications, form links and associations, upload and post shared content, such as images, image compositions (e.g., albums that include one or more images, image collages, videos, etc.), audio data, and other types of content, receive various forms of data, and/or perform socially-related functions. For example, the network service can allow a user to send messages to a particular set of users or to multiple users, form social links in the form of associations with other users within the network service, group other users in user lists, friends lists, or other user groups, post or send content, including images, image compositions, text, videos, audio sequences or recordings, or other types of content that can be accessed by users of the network service, participate in live video, audio, and/or text videoconferences or chat sessions with other users of the service, etc. In some implementations, a “user” can include one or more programs or virtual entities, as well as persons that interface with the system or network.

A user interface can enable the display of images, image compositions, data, and other content as well as communications, privacy settings, notifications, and other data on client devices 120, 122, 124, and 126 (or alternatively, on the server system 102). Such an interface can be displayed using software on the client device(s), software on the server device 104, and/or a combination of client software and server software executing on the server device 104, e.g., application software or client software in communication with the server system 102. The user interface can be presented via a display device of the client device(s) or of the server device 104, e.g., a display screen, a projector, etc. In some implementations, application programs running on a server system can communicate with one or more client device(s) to receive user input at the client device(s) and to output data, such as visual data, audio data, etc., at the client device(s).

In some implementations, the server system 102 and/or one or more client devices 120-126 can include the ability to record media and associate the recorded media with a machine-readable indicium. The machine-readable indicium can be scanned subsequently to retrieve the media and play or display the media.

In particular, a user (e.g., U1) can use a device 120 (via a mobile application installed on the device or a connection to a web service, etc.) to scan or take an image of and decode a machine-readable indicium 134 printed on or affixed to a card, gift, product, packaging, wrapping, or other object 132. The machine-readable indicium 134 can include one or more of a QR code, a 2-D bar code (barcode), a 3-D bar code (barcode), alphanumeric characters, graphical symbols, or other machine-readable indicium. The machine-readable indicium 134 can be printed on the card, gift, product, packaging, wrapping, or other object 132, or can be provided as a sticker to be affixed to the card, gift, product, packaging, wrapping, or other object 132.

The user U1 can then record or upload one or more electronic media items to be associated with the machine-readable indicium. The electronic media items can include one or more of a video recording, an audio recording, one or more images (e.g., pictures, memes, etc.), one or more electronic documents, a code or other way to access electronic funds, or the like. The mobile application or web service can link a value corresponding to the machine-readable indicium with the uploaded or recorded media items. Then, the machine-readable indicium and the media item(s) are transmitted to the server 102 via the network 130. The server 102, via a machine-readable indicia messaging system application 108, processes the received information, and stores the media items(s) and the machine-readable indicium value in the database 106.

In some implementations, the user can send or give the card, gift, product, packaging, wrapping, or other object 132 to a recipient (e.g., user U2). The recipient, e.g., user U2, can scan the machine-readable indicium 134 on the item 132 using the client device 122. A mobile application on the client device 122 or a connection to a web service or other software causes the client device 122 to send information corresponding to the machine-readable indicium 134 to the server system 102 along with a request for any media items associated with the indicium 134.

Upon receiving the request from the client device 122, the server system 102 can provide to the client device 122 the one or more media items associated with the machine-readable indicium 134. The client device 122 can then display or play the received media items.

For example, a grandmother could purchase a greeting card with a machine-readable indicium in the form of a QR code. The grandmother can then scan the QR code and record herself giving a “Happy Birthday” message to one of her grandchildren. When the grandchild receives the greeting card, the grandchild can scan the QR code to hear or see the personalized “Happy Birthday” message from their grandmother.

Various implementations of features described herein can use any type of system and/or service. Any type of electronic device can make use of the features described herein. Some implementations can provide one or more features described herein on a client device or on a server device that is disconnected from or intermittently connected to a computer network.

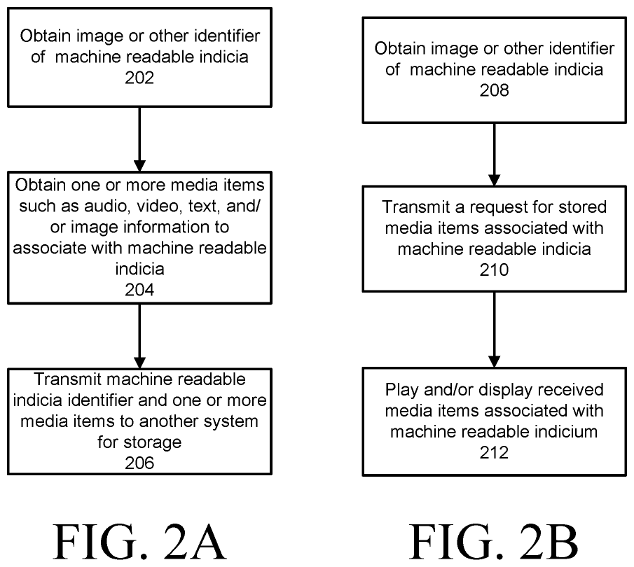

FIGS. 2A and 2B are illustrative flowcharts showing example methods for recording or playing back one or more example messages (or media items) in accordance with some implementations. The process shown in FIG. 2A begins at 202, where an image or other identifier of a machine-readable indicium is obtained. For example, a user could scan a QR code with a camera. In general, a new machine-readable indicium can be created or an existing machine-readable indicium can be utilized. The user could also type in letters or numbers associated with the QR code. In another example, a point-of-sale system at a store or other business location can print a machine-readable indicium sticker. Alternatively, a machine-readable indicium sticker can be scanned by the point-of-sale system at a store or business location. Processing continues to 204.

At 204, one or more media items are retrieved. The media items can be retrieved from on-device storage, recorded live, or retrieved from an external memory or system. The media items can include a video, an audio recording, an image, an electronic document, an electronic receipt, an electronic gift receipt, a link to electronic funds, etc. The media items and/or other electronic data associated with a machine-readable indicium can be user generated (e.g., an audio or video recording made by the user), store generated (e.g., a receipt, electronic gift card, or gift receipt), or a combination of user generated and store generated media items or electronic data. The user generated content can include one or more pieces of content from one or more users who have access to the corresponding machine-readable indicium. Processing continues to 206.

At 206, information corresponding to the machine-readable indicium (e.g., an identification number encoded within the machine-readable indicium) and the one or more media items or electronic data associated with the machine-readable indicium are transmitted to another system (e.g., a server system such as 102), and may be optionally stored in a database, e.g., 106.

The process shown in FIG. 2B begins at 208, where an image or other identifier of a machine-readable indicium is received. For example, a recipient of a card, a gift, or the like can scan using a camera of a client device (e.g., a smartphone) computer readable indicium affixed to the card, the gift, or the like received by the recipient user. Processing continues to 210.

At 210, the recipient client device transmits a request to receive at the recipient client device any stored media items. The retrieved media files can be displayed, presented, or played at the recipient client device. Processing continues to 212.

At 212, the one or more retrieved media items, pursuant to the request made in 210, are displayed, presented, and/or played for the recipient user.

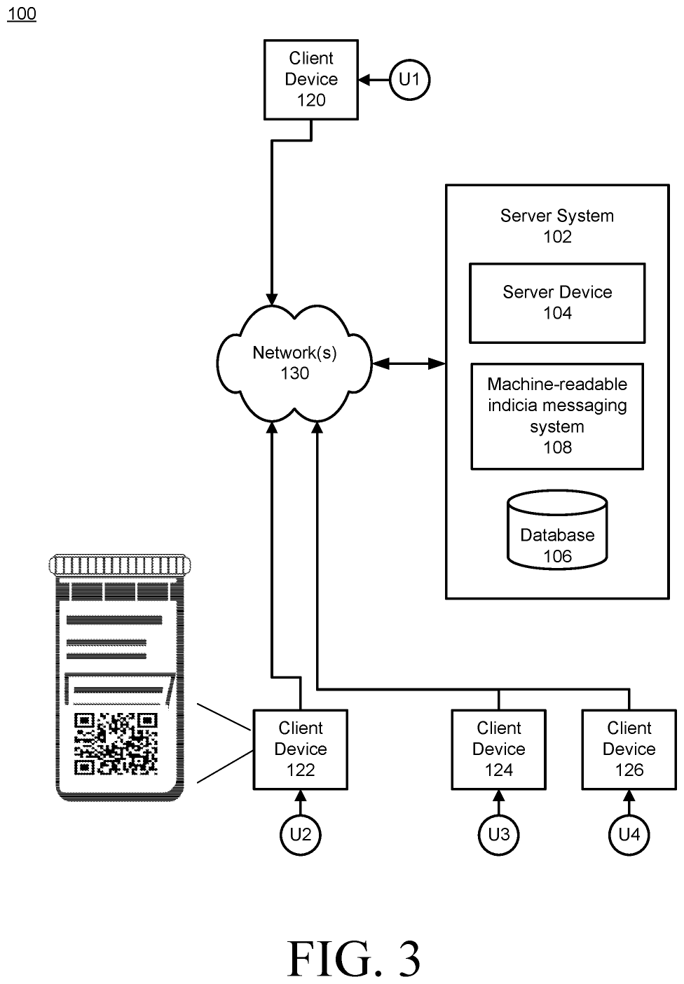

FIG. 3 is a block diagram of an example system and network environment for retrieving an example message (or media item) for a product in accordance with some implementations. The system in FIG. 3 is largely similar to that shown in FIG. 1. A difference between FIG. 1 and FIG. 3 is that the product 302 includes a machine-readable indicium 304 that can be affixed to the product at the time of manufacturing or labeling. Thus, there may be a media item (e.g., an audio recording of the product label information being read) that is associated with numerous products.

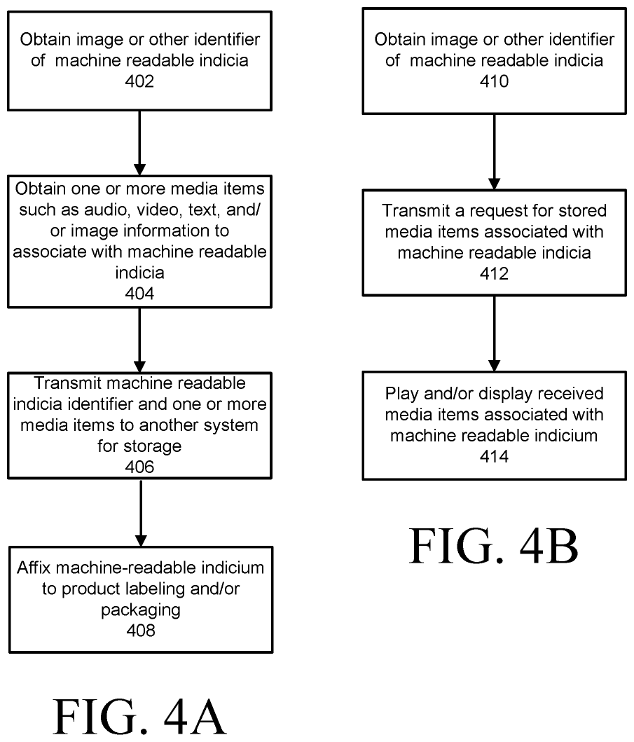

FIGS. 4A and 4B are illustrative flowcharts showing example methods for recording or retrieving example messages (or media items) for a product in accordance with some implementations. The process shown in FIG. 4A begins at 402, where an image or other identifier of a machine-readable indicium is obtained. For example, a one-time operation may be performed to obtain information about a machine-readable indicium that is associated with a media item and that is printed on labeling or packaging. For example, a user can scan a QR code with a camera and/or type in letters or numbers associated with the QR code. Processing continues to 404.

At 404, one or more media items are retrieved. The media items can be retrieved from on-device storage, recorded live, or retrieved from an external memory or system. The electronic media can include a video, an audio recording, an image, an electronic document, an electronic receipt, an electronic gift receipt, a link to electronic funds, etc. In this example, a recording of a person reading the label information for a product can be made. Processing continues to 406.

At 406, information corresponding to the machine-readable indicium (e.g., an identification number encoded within the machine-readable indicium) and the one or more media items or electronic data associated with the machine-readable indicium are transmitted to another system (e.g., a server system such as 102), and may be optionally stored in a database, e.g., 106. Processing continues to 408.

At 408, the machine-readable indicium is affixed to or printed onto product labeling, product wrapping, or product packaging.

The process shown in FIG. 4B begins at 410, where an image or other identifier of a machine-readable indicium is obtained. For example, a customer can scan using a camera of a client device (e.g., a smartphone) computer readable indicium affixed to a product, e.g., a retail product displayed at a store or other business location. Processing continues to 412.

At 412, the customer client device transmits a request to receive at the client device any stored media items. The media items can be displayed, presented, or played at the client device. Processing continues to 414.

At 414, the one or more retrieved media items, pursuant to the request made in 412, are displayed, presented, and/or played on the client device.

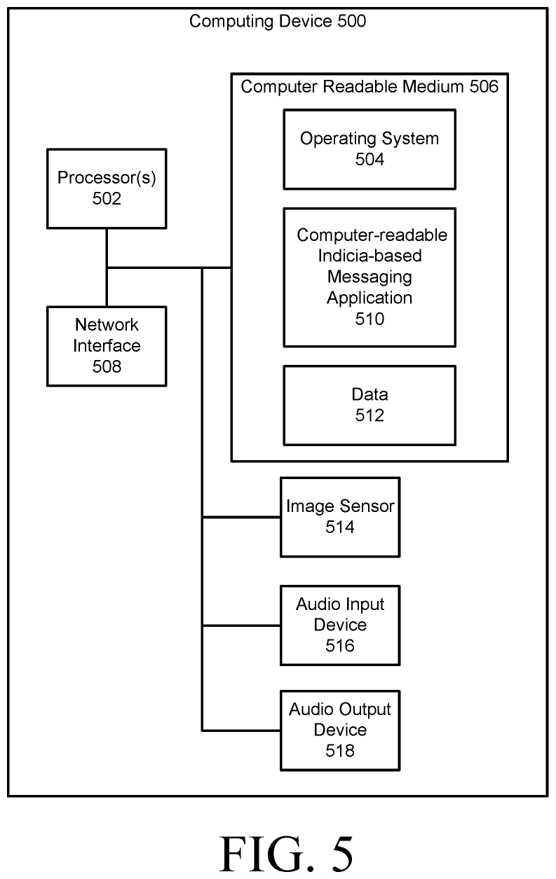

FIG. 5 is a block diagram of an example computing device that may be used for one or more implementations described herein. In some implementations, device 500 may be used to implement a client device, e.g., any of the client devices shown in FIG. 1, e.g., 122-126. Alternatively, device 500 can implement a server device, e.g., server device 104, etc. In some implementations, device 500 may be used to implement a client device, a server device, or a combination of a client device and a server device. Device 500 can include any suitable computer system, server, or other electronic or hardware devices as described above.

One or more methods described herein (e.g., FIGS. 2A, 2B, 4A, and/or 4B) can be implemented through a standalone program that can be executed on any type of computing device, a program that can be executed on a web browser or a mobile application (“app”) that can be executed on a mobile computing device (e.g., cellphone, smartphone, tablet computer, wearable device (wristwatch, armband, jewelry, headwear, virtual reality goggles or glasses, augmented reality goggles or glasses, head mounted display, etc.), laptop computer, etc.).

In some implementations, a client/server architecture can be used. For example, a client device, e.g., a mobile computing device, sends user input data to a server device and receives from the server data for output, e.g., for display. In some implementations, all of the computations can be performed in apps on a mobile computing device. In another example, computations can be split among a mobile computing device and one or more server devices.

In some implementations, device 500 includes a processor 502 and a memory 506. Processor 502 can include one or more processors and/or processing circuits for executing program code and performing basic operations of device 500. A “processor” includes any suitable hardware system, mechanism, or component that processes data, signals, or other information. A processor may include a system with a general-purpose central processing unit (CPU) with one or more cores (e.g., single-core, dual-core, or multi-core configuration), multiple processing units (e.g., a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, processor 502 may include one or more co-processors that implement neural-network processing. In some implementations, the processor 502 may be a processor that processes data to produce probabilistic output, e.g., the output produced by processor 502 may be imprecise or may be accurate within a range of expected output. Processing need not be limited to a particular geographic location or have temporal limitations. For example, a processor may perform its functions in “real-time,” “offline,” in a “batch mode,” etc. One or more parts of the processing may be performed at different times and/or at different locations by different (or the same) processing systems. A computer may be any processor in communication with a memory.

Memory 506 is typically provided in device 500 for access by processor 502 and may be any suitable processor-readable storage medium, such as a random-access memory (RAM), a read-only memory (ROM), an Electrically Erasable Read-only Memory (EEPROM), a flash memory, etc., suitable for storing instructions for execution by a processor. Memory 506 may be located separate from processor 502 and/or may be integrated with processor 502. Memory 506 can store software executed on the server device 500 by processor 502. Such software may include an operating system 504, a computer-readable indicia-based messaging application 510, and application data 512. Other applications may include applications such as a data display engine, a web-hosting engine, an image display engine, a notification engine, a social networking engine, etc. In some implementations, the computer-readable indicia-based messaging application 510 can each include instructions that enable processor 502 to perform functions described herein, e.g., some or all of the methods shown in FIG. 2A, 2B, 4A, or 4B.

Any of the software 510 in memory 506 can alternatively be stored on any other suitable storage location or computer-readable medium. In addition, memory 506 (and/or other connected storage device(s)) can store one or more messages, one or more taxonomies, one or more electronic encyclopedia, one or more dictionaries, one or more thesauruses, one or more knowledge bases, message data, grammars, user preferences, and/or other instructions and/or data used in the features described herein. Memory 506 and any other type of storage that may be used herein (e.g., magnetic disk, optical disk, magnetic tape, or other tangible media) can be considered to be “nontransitory computer readable media,” “storage,” or “storage devices.”

The network interface 508 can provide functions to enable the interfacing of the device 500 with other systems or devices. Interfaced devices can be included as part of the device 500 or can be separate and communicate with the device 500 remotely. For example, both wired and wireless network communication devices can communicate via the network interface 508. In some implementations, the device 500 can connect to interface devices such as input devices (e.g., keyboard, pointing device, touchscreen, microphone, camera, scanner, sensors, etc.) and/or output devices (e.g., display devices, speaker devices, printers, motors, etc.).

Examples of devices that can interface with and/or connect with the device 500 can include one or more display devices. The display devices can be used to display content, e.g., a user interface of an output application as described herein. Display devices can be connected to the device 500 via local connections (e.g., display bus) or via networked connections and can be any suitable display device. Display devices can include any suitable display device such as an LCD, LED, or plasma display screen, CRT, television, monitor, touchscreen, 3-D display screen, or any other visual display device. For example, a display device can include screen(s) provided on a mobile device or in goggles or headset devices, or a monitor screen in a computer device.

The I/O interface 508 can interface or connect with other input or output devices. Some examples include one or more cameras that can capture images. Some implementations can provide a microphone for capturing sound (e.g., as part of captured images, voice commands, etc.), audio speaker devices for outputting sound, or other input and output devices.

For ease of illustration, FIG. 5 shows one block for processor 502, one software block each for the operating system 504, application 510, and data 512, and one block each for memory 506, the network interface 508, the image sensor 514, the audio input device 516, and the audio output device 518. These blocks may represent one or more processors or processing circuitries, operating systems, memories, I/O interfaces, applications, and/or software modules. In other implementations, the device 500 may not have all of the components shown and/or may have other elements, including other types of elements instead of, or in addition to, those shown herein. While some components are described as performing blocks and/or operations in some implementations herein, any suitable component or a combination of components in environment 100, device 500, or similar systems, or any suitable processor or processors associated with such a system may perform the blocks and/or operations described herein.

One or more methods described herein (e.g., the methods shown in FIGS. 2A, 2B, 4A, and/or 4B) can be implemented by computer program instructions or code, which can be executed on a computer. For example, the code can be implemented by one or more digital processors (e.g., microprocessors or other processing circuitry) and can be stored on a computer program product, including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in and provided as an electronic signal, for example, in the form of software as a service (SaaS) delivered from a server (e.g., a distributed system and/or a cloud computing system). Alternatively, one or more methods can be implemented in hardware (logic gates, etc.) or in a combination of hardware and software. Example hardware can be programmable processors (e.g., Field-Programmable Gate Array (FPGA) and/or Complex Programmable Logic Device (CPLD)), general purpose processors, graphics processors, Application Specific Integrated Circuits (ASICs), and the like. One or more methods can be performed as part of a component of an application running on a system or as an application or software running in conjunction with other applications and an operating system.

One or more methods described herein (e.g., FIGS. 2A, 2B, 4A, and/or 4B) can be implemented through a standalone program that can be executed on any type of a computing device, a program that can be executed on a web browser, or a mobile application (“app”) that can be executed on a mobile computing device (e.g., cellphone, smartphone, tablet computer, wearable device (wristwatch, armband, jewelry, headwear, virtual reality goggles or glasses, augmented reality goggles or glasses, head mounted display, etc.), laptop computer, etc.). In some implementations, a client/server architecture can be used, where a client device (e.g., a mobile computing device) sends user input data to a server device and receives from the server data for output (e.g., for display). In another example, all computations can be performed within a mobile app (and/or other apps) on a mobile computing device. In another example, computations can be split among a mobile computing device and one or more server devices.

Although the disclosure has been described with respect to particular implementations thereof, these particular implementations are merely illustrative, and not restrictive. Concepts illustrated in the implementations herein may be applied to other examples and implementations.

The functional blocks, operations, features, methods, devices, and systems described in the present disclosure may be integrated or divided into different combinations of systems, devices, and functional blocks. Any suitable programming language or programming techniques may be used to implement the routines of a particular implementation. Different programming techniques may be employed, e.g., procedural or object-oriented. The routines may execute on a single processing device or multiple processors. Although the steps, operations, or computations may be presented in a specific order, their order may be changed in a particular implementation and one or more steps may be omitted in an implementation. In some implementations, multiple steps or operations shown as sequential in this specification may be performed at the same time.

What is claimed is:

1. A system comprising:
a server system, wherein the server system comprises a server device and a database, wherein a value corresponding to a machine-readable indicium is received at the server system in response to the machine-readable indicium being scanned by a first client device, wherein one or more media items associated with the value are received at the server system from the first client device, and wherein the value corresponding to the machine-readable indicium and the one or more media items are stored in the database and the value is associated with one or more media items in the database; and
wherein, in response to receiving the value and a request for the one or more media items from a second client device, the server system transmits the one or more media items from the server system through one or more networks to the second client device.

2. The system of claim 1, wherein the machine-readable indicium includes one or more of a QR code, a 2-D barcode, a 3-D barcode, alphanumeric characters, or graphical symbols.

3. The system of claim 1, wherein the machine-readable indicium is printed on one of a card, a gift, a product, a packaging, or a wrapping.

4. The system of claim 1, wherein the machine-readable indicium is affixed as a sticker to one of a card, a gift, a product, a packaging, or a wrapping.

5. The system of claim 1, wherein the one or more media items include one or more of a video recording, an audio recording, one or more images, one or more electronic documents, or one or more codes to access one or more electronic funds.

6. The system of claim 1, wherein one or more of the one or more media items is generated by a customer.

7. The system of claim 1, wherein one or more of the one or more media items is generated by a service provider.

8. A method comprising:
receiving at a server system a value corresponding to a machine-readable indicium, wherein the value was obtained by scanning the machine-readable indicium at a first client device;
receiving one or more media items associated with the value from the first client device at the server system;
storing the value corresponding to the machine-readable indicium and the one or more media items in a database;
associating in the database the value corresponding to the machine-readable indicium with the one or more media items;
receiving the value corresponding to the machine-readable indicium and a request for the one or more media items from a second client device; and
transmitting from the server system, in response to the request for the one or more media items, the one or more media items to the second client device for presentation on the second client device.

9. The method of claim 8, wherein the machine-readable indicium includes one or more of a QR code, a 2-D barcode, a 3-D barcode, alphanumeric characters, or graphical symbols.

10. The method of claim 8, wherein the machine-readable indicium is printed on one of a card, a gift, a product, a packaging, or a wrapping.

11. The method of claim 8, wherein the machine-readable indicium is affixed as a sticker to one of a card, a gift, a product, a packaging, or a wrapping.

12. The method of claim 8, wherein the one or more media items include one or more of a video recording, an audio recording, one or more images, one or more electronic documents, or one or more codes to access one or more electronic funds.

13. The method of claim 8, wherein one or more of the one or more media items is generated by a customer.

14. The method of claim 8, wherein one or more of the one or more media items is generated by a service provider.

15. A method comprising:
affixing a machine-readable indicium to a product;
receiving at a server system a value corresponding to a scanned machine-readable indicium, wherein the value was obtained by scanning the machine-readable indicium at a first client device;
receiving one or more media items associated with the value from the first client device at the server system;
storing the value corresponding to the machine-readable indicium and the one or more media items in a database;
associating in the database the value corresponding to the machine-readable indicium with the one or more media items;
receiving the value corresponding to the machine-readable indicium and a request for the one or more media items from a second client device; and
transmitting from the server system, in response to the request for the one or more media items, the one or more media items to the second client device for presentation on the second client device.

16. The method of claim 15, wherein the machine-readable indicium includes one or more of a QR code, a 2-D barcode, a 3-D barcode, alphanumeric characters, or graphical symbols.

17. The method of claim 15, wherein the machine-readable indicium is printed on one of a card, a gift, a product, a packaging, or a wrapping.

18. The method of claim 15, wherein the machine-readable indicium is affixed as a sticker to one of a card, a gift, a product, a packaging, or a wrapping.

19. The method of claim 15, wherein the one or more media items include one or more of a video recording, an audio recording, one or more images, one or more electronic documents, or one or more codes to access one or more electronic funds.

20. The method of claim 15, wherein one or more of the one or more media items is generated by one or more of a customer or a service provider.
